(19) United States
(12) Patent Application Publication
(10) Pub. No.: US 2009/0319846 A1
(43) Pub. Date: Dec. 24, 2009

(54) ADAPTIVE ERROR CORRECTION METHOD FOR DATA TRANSMISSION AND DEVICES THEREOF

(75) Inventors: Xiaojun Ma, Beijing (CN); Jun Li, Beijing (CN); Hang Liu, Bucks, PA (US)

Correspondence Address: Robert D. Shedd, Patent Operations;THOMSON Licensing LLC, P.O. Box 5312, Princeton, NJ, 08543-5312, US

(73) Assignee: Thomson Corporation, Princeton, NJ (US)

(21) Appl. No.: 12/448,536

(22) PCT Filed: Dec. 30, 2006
(86) PCT No.: PCT/CN2006/003791

§ 371 Date: Jun. 24, 2009

(51) Int. Cl. G06F 11/07; H04H 20/71

(52) U.S. Cl. 714/747; 714/799; 370/312; 714/E11.023; 714/E11.024

(57) ABSTRACT

An adaptive error correction method for data transmission and the devices thereof are disclosed. By comparing the announced recovery data and data requested for error correction, no redundant join messages will be sent if the recovery data have been announced before. This will greatly reduce the number messages and save the band width of transmission.

### FIELD OF THE INVENTION

The present invention generally relates to transmission of data over networks and, more particularly, to techniques for loss recovery of multicasting data transmitted over networks.

### BACKGROUND OF THE INVENTION

Video streaming services such as movie broadcast, distance learning or video conference over networks have generated great interests nowadays. These services in general involve point to multi-point communication in which data from a video source will be delivered to a group of clients over networks. However quality of these services may be degraded due to loss of data packets during transmission. Conventional approaches for error correction can be divided into two categories: FEC (Forward Error Correction) and ARQ (Automatic Repeat Request).

FEC combines redundant packets of FEC groups in addition to a main data group from the video source. However, FEC is designed for the worst case and it may carry too much redundant data under normal conditions. Moreover, for some FEC schemes such as Reed-Solomon codes, if a client loses M packets out of N, it must receive at least M FEC packets to recover the loss. Otherwise, none of the M packets can be recovered. Therefore, because of the large overhead FEC is not effective enough for long error burst case, such as channel scan or handoff during the video session.

Under ARQ scheme as illustrated in FIG. 1, clients will feedback the sequence numbers of the lost packets back to the server in join messages, so that the server can re-transmits those packets to the clients for error correction. However, one disadvantage of the ARQ based approach is feedback implosion. Without awareness of feedback of other clients, a client may send out join messages that have been already activated by other clients to the server. Due to this redundancy of join messages, there may be a feedback implosion and bandwidth waste when the number of clients is large. Moreover, the recovery time of ARQ scheme is comparatively long due to the feedback delay and pruning delay.

Therefore, a method is needed for the case of long burst of loss, which may reduce the signalling overhead and save the transmission bandwidth.

### SUMMARY OF THE INVENTION

In one aspect of the present invention, An adaptive error correction method for data transmission, including the steps of: inspecting a first data group to check the range of burst error; comparing the range of burst error with the range of a second data group announced; using at least portion of the second data group to recover the burst error if said range of burst error is within or the same as the range of the second data group announced.

Preferably, the method further comprise the steps of: sending a join message requesting for extension of the second data group if the range of burst error is out of the range of the second data group announced; announcing said extension of the second data group upon receipt of a join message; updating the range of the second data group announced by combining said extension with it.

Preferably, the announcement of the second data group stops when the range of burst error is fulfilled.

Preferable, the range of the second data group announced will be classified according to different applications.

Preferably, there is a fixed time difference between the announcement of the first data group and the second data group.

Preferably, the transmission can be realized via internet, wireless or terrestrial network.

In another aspect of the invention, a router in a data transmission network, comprising: a data receiving means for receiving a first and second data groups; a data transmitting means for announcing said first and second data groups; a message receiving means which receives join messages that contain the range of burst error; a processing means; and a message transmitting means; wherein, the processing means will compare the range of the burst error with the range of the second data group announced, if the range of burst error is out of the range of the second data group announced, the processing means will instruct the data transmitting means to announce an extension of the second data group corresponding to the difference between the two ranges, and the processing means will also update the range of the second data group announced by combining said extension with it; the message transmitting means will announce the updated range of the second data group.

Preferably, said router further comprises an access point which enables wireless transmission.

In yet another aspect of the invention, a client device in a data transmission network, comprising: a data receiving means which receives a first and second data groups announced; an error detection means which detects the error occurred in the first data group received; a message receiving means for receiving the updated range of the second data group announced; a processing means; and a message transmitting means; wherein said processing means compares the range of burst error detected with the range of the second data group announced, if the range of burst error is within or the same as the range of the second data group announced, the processing means won't instruct the message transmitting means to send a join message.

Preferably, if the range of burst error is out of the range of the second data group announced, the processing means will instruct the message transmitting means to send out a join message to request for an extension of the second data group.

### BRIEF DESCRIPTION OF THE DRAWINGS

FIG. 1 is a schematic diagram showing the error correction process under conventional ARQ scheme;

FIG. 2 is a schematic diagram showing error correction process under the error correction scheme according to present invention;

FIG. 3 is a flowchart showing the error correction method according to one embodiment of the present invention;

FIG. 4 is a schematic diagram showing the mapping between a main data group and an ARQ data group according to one embodiment of the present invention;

FIG. 5 is a block diagram of a multicasting router according to the present invention; and

FIG. 6 is a block diagram of a client device according to the present invention.

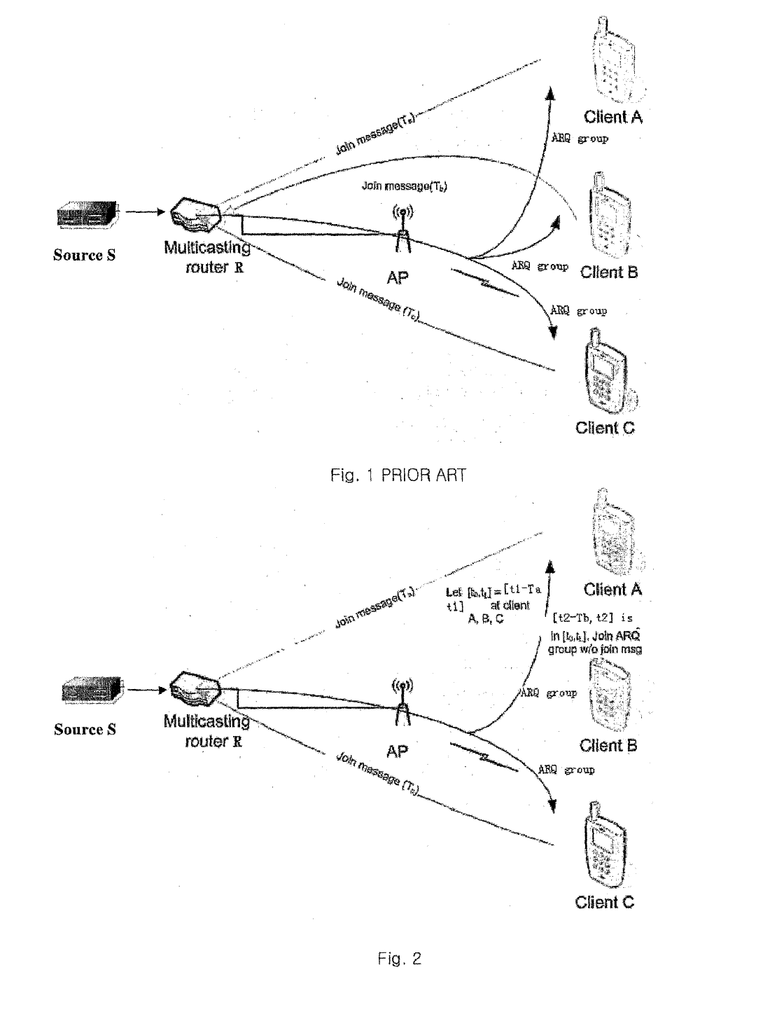

### DETAILED DESCRIPTION OF THE PREFERRED EMBODIMENTS

The technical features of the present invention will be described further with reference to the embodiments. The embodiments are only preferable examples without limiting to the present invention. It will be well understood by the following detail description in conjunction with the accompanying drawings.

According to one embodiment, a first data group is a set of data packets which were received by a client. A multicasting router R will first announce the sequence numbers of a second data group to be re-transmitted.

After a commonly known delay, the second data group which comprises a set of data packets will be re-transmitted by the multicasting router R and will be received by one or more clients. A sequence number is an identifier representing a data packet, which does not limit to any specific definition. FIG. 2 is a schematic diagram showing the error correction process according to the present invention. Original data are transmitted from a source S to a multicasting router R. The multicasting router R is responsible for announcing the data packets received from the source S in a main data group to N clients over a network, for example as illustrated in FIG. 2, N=3 and the clients are named A, B and C respectively. To correct the loss of packets in the main data group at client A or B or C, said multicasting router R is also used to announce a corresponding ARQ data group to the clients. The announcement of said ARQ group depends on the receipt of join messages sent by clients. However, said join messages won't be activated if requested ARQ data have been announced before. Detailed steps are described as below.

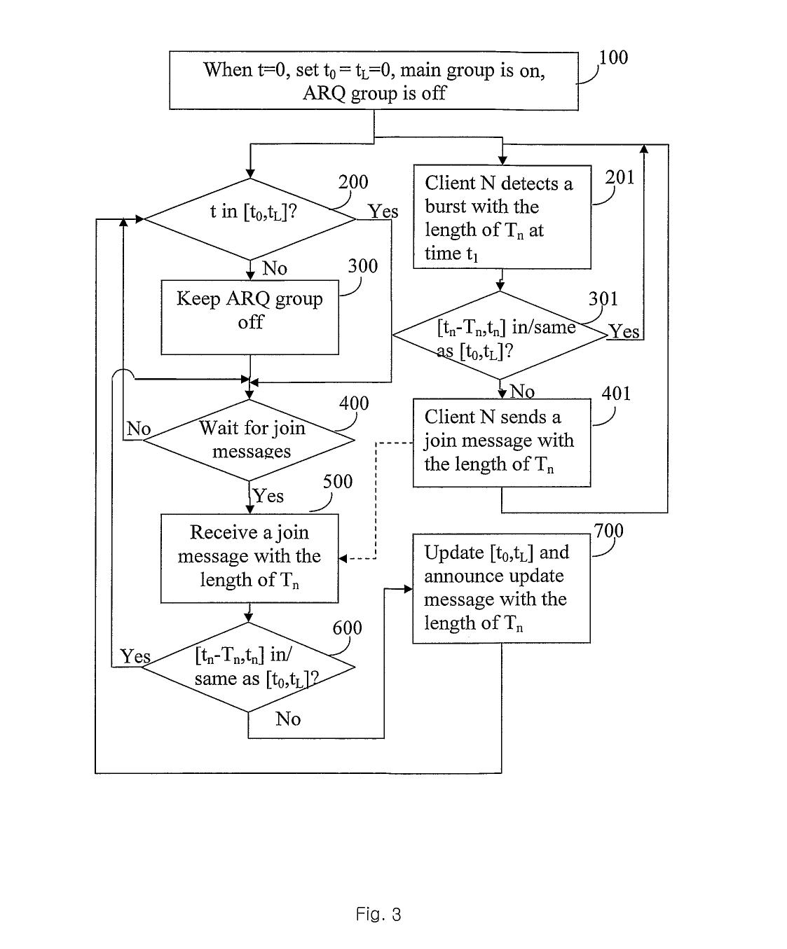

FIG. 3 is a flowchart of the error correction process according to one embodiment of the present invention. Each of clients A, B, C subscribes to a main data group. When t=0, at step 100 the main group is turned on by the router R while the ARQ group for error correction is kept off. [t₀, t_{L}] represents the range of ARQ data that have been announced. Both t₀ and t_{L} are set to be 0 when t=0. At step 200, the router R will check the relationship between t and [t₀, t_{L}]. At t=0 the ARQ group will still be kept off at step 300. Then the router R will wait for join messages from the clients at step 400. When t=t₁, at step 201 the client A detects a burst of loss with the length of Tₐ. At step 301, it will be determined by client A that if the range of burst error [t₁−Tₐ, t₁] is within or the same as [t₀, t_{L}]. Since t₀ and t_{L} are set to be 0 at step 100 when t=0 and no updates have been made yet, client A will send a join message with [t₁−Tₐ, t₁] to the router R at step 401 to request for corresponding ARQ data for error correction. After receiving the join message at step 500, the router R will determine the relationship between [t₁−Tₐ, t₁] and [t₀, t_{L}] as well at step 600. Since [t₁−Tₐ, t₁] is not within or the same as [t₀, t_{L}], at step 700 the multicasting router R will then turn on the ARQ group and ARQ data corresponding to [t₁−Tₐ, t₁] will be announced to client A. Then [t₀, t_{L}] will be updated accordingly by the router R, where t₀=t₁−Tₐ and t_{L}=t₁. Clients A, B and C will listen to an update message containing the updated [t₀, t_{L}], and receive the ARQ data if needed. Then client A will go back to step 201 and the router R will go back to step 200 to check if t is still within [t₀, t_{L}]. If the result is positive, which means the ARQ data are still under transmission to the clients, the router R will directly jump to step 400 to wait for new join messages. If the result is negative, the router R will turn off the ARQ group at step 300 and go to step 400.

When t=t₂, at step 201 client B detects a burst error of loss with the length of T_{b} and intends to join the ARQ multicasting group. However, at step 301 the range of burst error [t₂−T_{b}, t₂] is determined to be within or the same as [t₀, t_{L}], which means the corresponding ARQ data needed have been already received by client B, thus there is no need for client B to send a join message or to join the ARQ group again. Therefore client B will directly go back to step 201 for further error detection.

When t=t₃, at step 201 client C detects a burst error with the length of T_{c} and intends to join the ARQ multicasting group. At step 301 it is decided that [t₃−T_{c}, t₃] is different from [t₀, t_{L}] and there is an overlap between the two. According to one embodiment of the present invention, at step 401 client C will send a join message with the range of burst error [t₃−T_{c}, t₃]. After receiving such join message at step 500, the router R will do a comparison between [t₃−T_{c}, t₃] and [t₀, t_{L}] at step 600, so that ARQ data corresponding to the portion of [t₃−T_{c}, t₃] which is not included in [t₀, t_{L}] will be announced to the clients at step 700. At step 600, the router R will also combine join messages from different clients to combine request for the same ARQ data, so that the ARQ data announced at step 700 will be applied to different clients. [t₀, t_{L}] will be updated to include the range of newly announced ARQ data at step 700. Clients A, B and C receive the announced ARQ data and memorize the updated [t₀, t_{L}]. According to another embodiment of the present invention, at step 301, instead of [t₃−T_{c}, t₃], client C will send a join message with the range which is the part of [t₃−T_{c}, t₃] that is not included in [t₀, t_{L}] . Therefore, at step 600 the router R only has to combine requests from different clients.

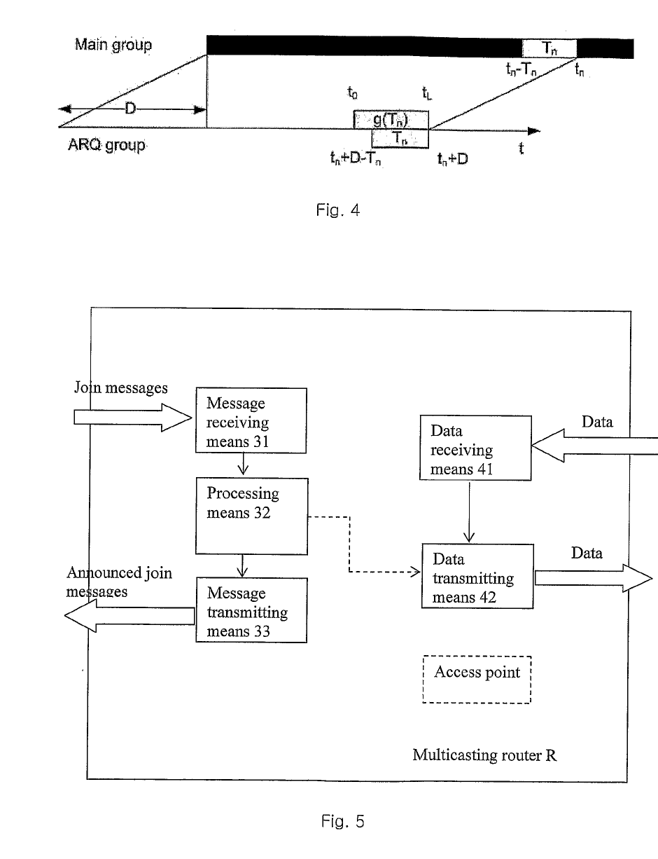

According to yet another embodiment of the present invention, a fixed time period D between the ARQ data group and the main group is defined, assuming all burst error lengths are less than D. FIG. 4 is a schematic diagram showing the mapping between the ARQ group and the main group according to one embodiment of the present invention. When a client detects a burst error of loss with the length of Tₙ, it may send a join message to the router and receive the corresponding ARQ data for error correction after a fixed time period of D. For example, as mentioned above, when t=t1, [t₀, t_{L}] should correspond to [tₙ+D−Tₙ, tₙ+D]. This will give the clients a proper period of time to request and receive ARQ data for error correction, without significant delay of transmission.

According to another embodiment of the present invention as shown in FIG. 4, the lengths of ARQ data may not necessarily be the same as the lengths of burst error, but represented by g(x). With this g(x), the length of ARQ data are divided into several categories according to different applications denoted as x. Due to the limited number of g(x), only a few bits are needed to indicate the burst length. For example, the temporal events can be divided into three classes, moving object blocking (200 ms), channel scanning (100 ms), handoff association (50 ms) based on real measurements. In this case, the join and update messages have to include only 2 bits information to identify a data length.

FIG. 5 is a block diagram of a multicasting router for data transmission. A data receiving means 41 is responsible for receiving data from a data source S. A data transmitting means 42 is responsible for announcing the main data group. A message receiving means 31 receives join messages from different clients and passes them to a processing means 32. The processing means 32 is responsible to make determinations regarding the relationship between requests from different clients and the relationship between the range of burst error contained in the join message and [t₀, t_{L}]. Based on the results of determination, requests for the same ARQ data will be combined and if the range of burst error is within or the same as [t₀, t_{L}], no duplicate ARQ data will be announced, and if the range of burst error is out of [t₀, t_{L}], only the range of ARQ data which is not included in [t₀, t_{L}] will be announced by the data transmitting means 42. The processing means 32 will also update [t₀, t_{L}] to include the newly announced ARQ data. The message transmitting means 33 will then announce the updated [t₀, t_{L}]. According to one embodiment of present invention, the router may further include an access point for data and message transmitting/receiving for wireless applications.

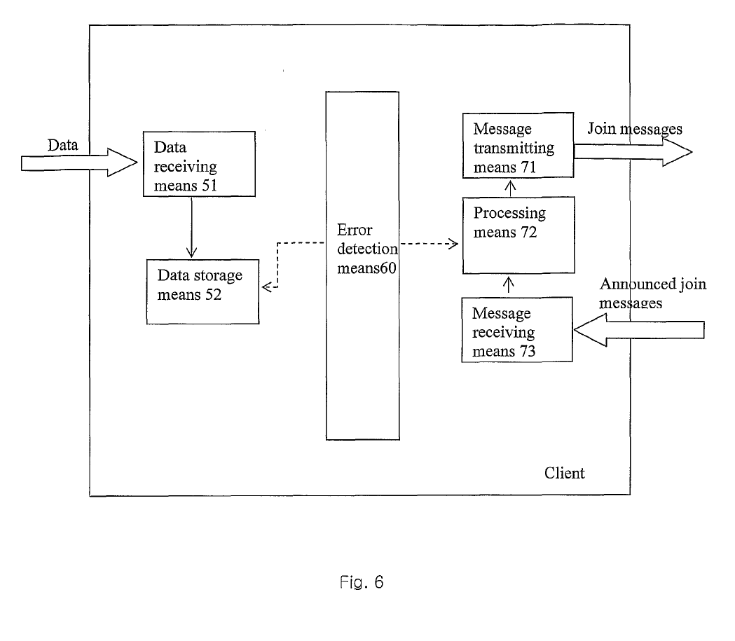

FIG. 6 is a block diagram of a client device. A data receiving means 51 receives main data groups and the data are saved in a data storage means 52. An error detection means 60 will inspect said received main data groups and find out the burst error of loss therein. Then the error detection means 60 will pass the detection results to a processing means 72. The processing means 72 will compare the range of burst error with [t₀, t_{L}]. If the burst length is within or the same as the range of [t₀, t_{L}], then it means the ARQ data needed for error correction have been received before or will be received soon so that no join messages will be sent at all. The burst error could be recovered by using at least portion of the received or to be received data. Otherwise, the processing means 72 will instruct a message transmitting means 71 to send out join messages requesting for ARQ data with the range of burst error or a partial range of burst error which is not included in [t₀, t_{L}]. ARQ data which corresponds to the partial range that is not included in [t₀, t_{L}] will be transmitted to the data receiving means 51 upon the receipt of join messages. A message receiving means 73 will listen to announced update messages with updated [t₀, t_{L}] which includes the range of newly announced ARQ data.

By doing so, the number of join messages sent to the router R is greatly reduced, the announcing efficiency of router R is obviously increased and the bandwidth of transmission is saved. Furthermore, in a normal multicasting protocol implementation, the ARQ data group will be pruned after the multicasting router detects no member in the ARQ group. Therefore a pruning delay is needed for the member detection even if actually there is no member in the group during the delay period. With this invention, the announcement of ARQ data will be stopped as long as [t₀, t_{L}] (or the extension of [t₀, t_{L}]) expires, which eliminates useless load caused by pruning delay.

Besides, aforementioned method and devices can be applied over different kinds of network such as internet, wireless or terrestrial network, and can be used for different kinds of data transmission video multicasting.

Whilst there has been described in the forgoing description preferred embodiments and aspects of the present invention, it will be understood by those skilled in the art that many variations in details of design or construction may be made without departing from the present invention. The present invention extends to all features disclosed both individually, and in all possible permutations and combinations.

1-10. (canceled)

11. An adaptive error correction method for data transmission, including the steps of:
inspecting a first data group to check the range of burst error;
comparing the range of burst error with the range of a second data group announced;
using at least portion of the second data group to recover the burst error if said range of burst error is within or the same as the range of the second data group announced.

12. The method according to claim 11, further comprise the steps of:
sending a join message requesting for extension of the second data group if the range of burst error is out of the range of the second data group announced;
announcing said extension of the second data group upon receipt of a join message;
updating the range of the second data group announced by combining said extension with it.

13. The method according to claim 11, wherein the announcement of the second data group stops when the range of burst error is fulfilled.

14. The method according to claim 11, wherein the range of the second data group announced will be classified according to different applications.

15. The method according to claim 14, wherein there is a fixed time difference between the announcement of the first data group and the second data group.

16. The method according to claim 15, wherein the transmission can be realized via internet, wireless or terrestrial network.

17. A communication method in a data transmission network having a source, a router and at least two client devices, wherein the method comprises, at the level of the router, the steps of:
receiving a first and a second data groups from the source;
transmitting said first data group to the client devices;
announcing said second data group to the client devices;
receiving from the client devices information that contains a range of the lost data of the transmitted first data group; and
determining whether to announce an updated second data group as a function of the comparison between the range of lost data and that of the second data group.

18. The method according to claim 17, wherein if the range of lost data is within or the same as the range of the second data group, the router does not announce an updated second data group.

19. The method according to claim 17, wherein if the range of lost data is out of the range of the second data group, the router announce an updated second data group which comprises only the range of the lost data not included in the range of the second data group.

20. The method according to claim 17, wherein said router further comprises an access point which enables wireless transmission.

21. A communication method in a data transmission network having a source, a router and at least two client devices, wherein the method comprises, at the level of the client device, the steps of:
receiving a first data group transmitted from the router;
receiving a second data group announced by the router;
detecting a data loss in the first data group received;
determining whether to transmit information that contains a range of the lost data to the router as a function of the comparison between the range of lost data and that of the second data group.

22. The method according to claim 21, wherein if the range of lost data is within or the same as the range of the second data group, the client device does not transmit the information to the router and listen to the updated second data group from the router.

23. The method according to claim 21, wherein if the range of lost data is out of the range of the second data group, the client device transmit the information to the router and recover the data loss using at least portion of the second data group announced by the router.
